(19) United States
(12) Patent Application Publication
(10) Pub. No.: US 2025/0106913 A1
(43) Pub. Date: Mar. 27, 2025

(54) METHOD AND APPARATUS FOR PROVIDING OF VIRTUAL L2 SWITCH SERVICE

(71) Applicant: KT CORPORATION, Gyeonggi-do (KR)

(72) Inventors: Jin-Geun LEE, Gyeonggi-do (KR); Sung-Gyun KANG, Gyeonggi-do (KR); Il-Yong KIM, Gyeonggi-do (KR); Tae-Young SHIN, Gyeonggi-do (KR); Won-Chang CHO, Gyeonggi-do (KR)

(73) Assignee: KT CORPORATION, Gyeonggi-do (KR)

(21) Appl. No.: 18/898,597

(22) Filed: Sep. 26, 2024

(30) Foreign Application Priority Data
Sep. 26, 2023 (KR) 10-2023-0129295

(51) Int. Cl. H04W 76/12; H04L 12/46; H04W 40/22

(52) U.S. Cl. CPC H04W 76/12; H04L 12/4633; H04W 40/22

(57) ABSTRACT

Provided a virtual Layer 2 (L2) switch for providing a virtual L2 switch service to a factory network that includes at least one control device connected to the factory network through an L2 network and industrial terminals connected to the factory network through a wireless mobile network. The virtual L2 switch may include a plurality of wireless routers respectively connected to industrial terminals in the factory network, each configured to wirelessly connect a corresponding one of the industrial terminals to a service system in a remote location through the wireless mobile network; and a master switch connected to the at least one control device in the L2 network within the factory network, connected to the service system through both Internet network and the wireless mobile network, and configured to establish a virtual L2 network between the at least one control device and the industrial terminals through the service provision server and enable the at least one control device and the industrial terminals to communicate with each other through the virtual L2 network.

### BACKGROUND

The present disclosure relates to a method and apparatus for providing a virtual layer 2 (L2) switch service in a 5G communication system. In particular, the present disclosure relates to a method and apparatus for establishing a virtual L2 network between devices connected to a factor network through an Ethernet network and devices connected to the factory network through a mobile network.

The Non-Stand Alone (NSA) model is an architecture used during the initial rollout of 5G technology. It allows for the integration of 5G with existing 4G LTE infrastructure. The core network of the 5G NSA model is a typical 4G LTE core network. In particular, the 5G NSA model relies on the 4G LTE core network (Evolved Packet Core: EPC) to handle essential tasks such as data management, signaling, and control. This means that while the 5G NSA uses 5G radio access technology, it still depends on the 4G core for overall network management.

For radio access, new 5G radios (e.g., gNodeBs) are introduced to increase speed and capacity, but they operate alongside existing 4G LTE radios (e.g., eNodeBs). Therefore, both 4G and 5G radios work together to deliver faster data speeds and lower latency.

The NSA model was designed to enable faster deployment of 5G by reusing the existing 4G infrastructure, without requiring a complete overhaul to a 5G-only network. It helped network operators introduce 5G services more quickly while reducing costs. However, in the NSA model, 5G's full potential, like ultra-low latency and more advanced features, is limited because the network still depends on the 4G core. On the other hand, the Stand-Alone (SA) model is fully independent, with a 5G core and radio access, allowing it to deliver all the advanced capabilities that 5G promises.

It is now evolving into the stand alone (SA) model, which supports 5G all the way to the core network. The 5G SA model supports network slicing, service-based architecture, separation of control and user planes, Mobile Edge Computing (MEC), specialized networks, and time sensitive networking (TSN), which is supported, making it suitable for various industrial applications.

Specially, 5G SA can provide additional support for Ethernet connectivity, which was not available before, to support industrial networks. The 5G Ethernet connectivity can be used to enable wireless non-IP (industrial Ethernet) connections between programmable logic controllers (PLCs) and sensors/actuators in factories. However, 5G SA devices have yet to be widely commercialized. Finding devices that support the 5G Ethernet type is challenging. As a result, many key nodes in the 5G SA core network still lack support for the 5G Ethernet type.

As an alternative, Ethernet gateway technology can be applied, which can operate not only in 5G SA but also in LTE or 5G NSA, enabling end-to-end (E2E) Ethernet connectivity to be provided. This technology is network-independent, so it can expand nationwide as soon as it is applied and can also extend globally through roaming.

The L2 layer (e.g., data link layer) is responsible for providing a reliable link between directly connected devices, facilitating the transfer of data over a physical network. Ethernet operates at the data link layer (Layer 2: L2) of the OSI model. The data link layer (L2) handles two main tasks: i) framing and ii) MAC addressing. Ethernet's roles at the data link layer (L2) are a) Ethernet defines how data is formatted into frames and transmitted between devices on a local area network (LAN), b) it uses MAC addresses to ensure that data is sent to the correct device within the same network, and c) Ethernet also manages error detection at the data link layer, ensuring that data corruption during transmission is identified.

That is, the Internet is made up of both L2 switches, which handle data traffic within local networks, and L3 switches (routers), which route data between different networks. L3 switches (or routers) handle IP routing, sending data across different networks, while L2 switches manage local traffic within a single network.

As described, L2 switches cannot perform routing but do support features like i) MAC learning: L2 switch learns the MAC address (unique hardware addresses) of the devices connected to it. When a device sends data, the switch records which port that device is connected to. This way, the L2 switch knows exactly where to send future data meant for that device. This allows the switch to know exactly where to send future data, ii) broadcasting: when an L2 switch receives data that needs to be sent to all devices on the network, it sends the same message to every connected devices, and iii) flooding: if the switch doesn't know the MAC address of the destination device, it will send the data to all ports to make sure it reaches the right device. This is called flooding. It's like sending the same letter to every in a building, hoping the right person gets it.

L2 switches typically use wired connections and have a limited number of physical ports where devices connect. This means there is a limit to how many devices can be connected to an L2 switch. Additionally, since L2 switches rely on cables to transmit data, there can be distance and location limitations. While the distance can be extended by installing repeaters (devices that amplify the signal to send it farther) or additional L2 switches, using wires still imposes a natural limit on the maximum transmission range.

Because of this, research has been conducted into wireless technologies for wired networks. In many cases, instead of converting the entire network to wireless, only the parts that need wireless connections are made wireless. For example, in a factory, field sensors and actuators could be made wireless, while centralized controllers (PLCs) remain connected to the existing wired network. This allows only the necessary parts to be wireless, while still making use of the wired network.

However, in such scenarios, a separate, expensive wired leased line is required to connect the factory's wired network to the telecom operator's 5G core network and L2 gateway. This increases the service costs, making it difficult to offer services on a smaller scale. In other words, the cost burden becomes higher.

### SUMMARY

In accordance with an aspect of the present disclosure, a 5G based virtual L2 switch service may be provided using 5G Ethernet Gateway technology.

In accordance with another aspect of the present disclosure, a viral L2 switch may be provided by converting a wired physical L2 switch into a virtual and wireless L2 switch by using a 5G router and L2 gateway.

In accordance with still another aspect of the present embodiment, a virtual L2 switch, a virtual L2 switch service provision system, and an L2 service provision method using the same may be provided for providing Ethernet connectivity thereby ensuring cost efficiency and stability when connecting to a wired network.

In accordance with further another aspect of the present disclosure, a virtual L2 switch, a virtual L2 switch service provision system, and an L2 service provision method using the same may be provided for allowing devices to connect and communicate with each other over a network by converting a wired physical L2 switch into a wireless one through a 5G router and L2 gateway.

In accordance with an embodiment, a virtual Layer 2 (L2) switch may be provided for providing a virtual L2 switch service to a factory network that includes at least one control device connected to the factory network through an L2 network and industrial terminals connected to the factory network through a wireless mobile network. The virtual L2 switch may include a plurality of wireless routers respectively connected to industrial terminals in the factory network, each configured to wirelessly connect a corresponding one of the industrial terminals to a service system in a remote location through the wireless mobile network, and a master switch connected to the at least one control device in the L2 network within the factory network, connected to the service system through both Internet network and the wireless mobile network, and configured to establish a virtual L2 network between the at least one control device and the industrial terminals through the service provision server and enable the at least one control device and the industrial terminals to communicate with each other through the virtual L2 network.

The master switch may establish, as the virtual L2 network, a wired L2 tunnel to the service system through the Internet network and a wireless L2 tunnel to the service system through the wireless mobile network.

The master switch receives L2 data traffic from and generated by the control device and delivers the received L2 data traffic through one of the wired L2 tunnel and the wireless L2 tunnel to the industrial terminals.

The master switch receives L2 data traffic from and generated by the industrial terminals through one of the wired L2 tunnel and the wireless L2 tunnel and delivers the received L2 data traffic to the control device.

As the wired L2 tunnel, the master switch separately establishes a first wired L2 tunnel from the master switch to a virtual private network (VPN) server included in the service system and a second wired L2 tunnel from the VPN server to a L2 data gateway of the service system.

The master switch include a switch configured to select one of the wired L2 tunnel and the wireless L2 tunnel to transmit the L2 data based on a predetermined protocol.

In accordance with another embodiment, a method may be provided for providing a virtual L2 switch service to a factory network that includes at least one control device connected to the factory network through an L2 network and industrial terminals connected to the factory network through a wireless mobile network, by using a virtual L2 switch including a plurality of wireless routers respectively connected to industrial terminals in the factory network, each configured to wirelessly connect a corresponding one of the industrial terminals to a service system in a remote location through the wireless mobile network, and a master switch connected to the at least one control device in the L2 network within the factory network, connected to the service system through both Internet network and the wireless mobile network. The method of the master switch may include establishing a virtual L2 network between the at least one control device and the industrial terminals through the service provision server, receiving L2 data traffic from the at least one control device or transmitting the received L2 data traffic to the industrial terminals through the virtual L2 network, and receiving L2 data traffic from the industrial terminals through the virtual L2 network and delivering the received L2 data traffic to the at least one control device.

The establishing a virtual L2 network may include establishing a wired L2 tunnel to the service system through the Internet network and establishing a wireless L2 tunnel to the service system through the wireless mobile network.

The establishing a wired L2 tunnel may include establishing a first wired L2 tunnel from the master switch to a virtual private network (VPN) server included in the service system; and establishing a second wired L2 tunnel from the VPN server to a L2 data gateway of the service system.

The transmitting of the L2 data traffic from and generated by the control device may include transmitting the received L2 data traffic through one of the wired L2 tunnel and the wireless L2 tunnel to the industrial terminals.

The transmitting of the L2 data traffic from and generated by the control device may further include selecting one of the wired L2 tunnel and the wireless L2 tunnel to transmit the L2 data based on a predetermined protocol.

In accordance with further another embodiment, a master switch may be provided for providing a virtual L2 switch service, with a plurality of wireless routers, to a factory network that includes at least one control device connected to the factory network through an L2 network and industrial terminals connected to the factory network through a wireless mobile network, the plurality of wireless routers respectively connected to industrial terminals in the factory network, each configured to wirelessly connect a corresponding one of the industrial terminals to a service system in a remote location through the wireless mobile network. The master switch may include an L2 port connected to the at least one control device in the L2 network within the factory network, an Internet port connected to the service system through Internet network, a mobile network modem configured to connect to the wireless mobile network, and a processor configured to establish a virtual L2 network between the at least one control device and the industrial terminals through the service provision server and enable the at least one control device and the industrial terminals to communicate with each other through the virtual L2 network.

The master switch may further include a L2 virtual private network (VPN) wired client circuit configured to form a wired L2 tunnel to the service system through the Internet network; and a L2 VPN wireless client circuit configured to form a wireless L2 tunnel to the service system through the wireless mobile network.

The master switch may further include a switch configured to select one of the wired L2 tunnel and the wireless L2 tunnel to transmit the L2 data based on a predetermined protocol.

### BRIEF DESCRIPTION OF THE DRAWINGS

FIG. 1 illustrates a typical L2 switch that establishes an Ethernet network for a local area network (LAN).

FIG. 2 illustrates a typical 5G factory network partially implemented wireless connection.

FIG. 3 is a diagram describing a virtual L2 switch service in accordance with an embodiment.

FIG. 4 is a block diagram illustrating a master router in accordance with an embodiment.

FIG. 5 is a diagram illustrating providing a virtual L2 switch service in accordance with an embodiment.

FIG. 6 is a flowchart illustrating a preparation procedure for providing a virtual L2 switch service in accordance with an embodiment.

FIG. 7 is a flowchart illustrating a method of a master router for providing virtual L2 switch service in accordance with an embodiment.

FIG. 8 is a signal diagram illustrating an activation procedure of a virtual L2 switch service in accordance with an embodiment.

FIG. 9 is a signal diagram illustrating establishing wireless connections between master router 210 and service system 100.

FIG. 10 is an exemplary diagram of a user data connection structure and protocol stack of a virtual L2 switch service according to an embodiment of the present invention.

### DETAILED DESCRIPTION OF EMBODIMENTS

In accordance with an embodiment, a virtual Ethernet network may be established between wired devices connected in a private Ethernet network and wireless devices connected to 5G core network, and the wired devices and the wireless devices are enabled to communicate each other through the virtual Ethernet network.

In accordance with an embodiment, L2 service provision server 110 and virtual L2 switch 200 may form a virtual L2 network and allows all of i) devices connected to an Ethernet network and ii) devices wirelessly connected to the 5G core network to communicate with each other as if all devices are connected to a single L2 network.

Hereinafter, a method and apparatus for providing a virtual L2 switch in accordance with an embodiment will be described with reference to the accompanying drawings. A virtual L2 switch, a virtual L2 switch service provision system, and a L2 service provision method using the same according to embodiments will be described in detail with reference to the accompanying drawings.

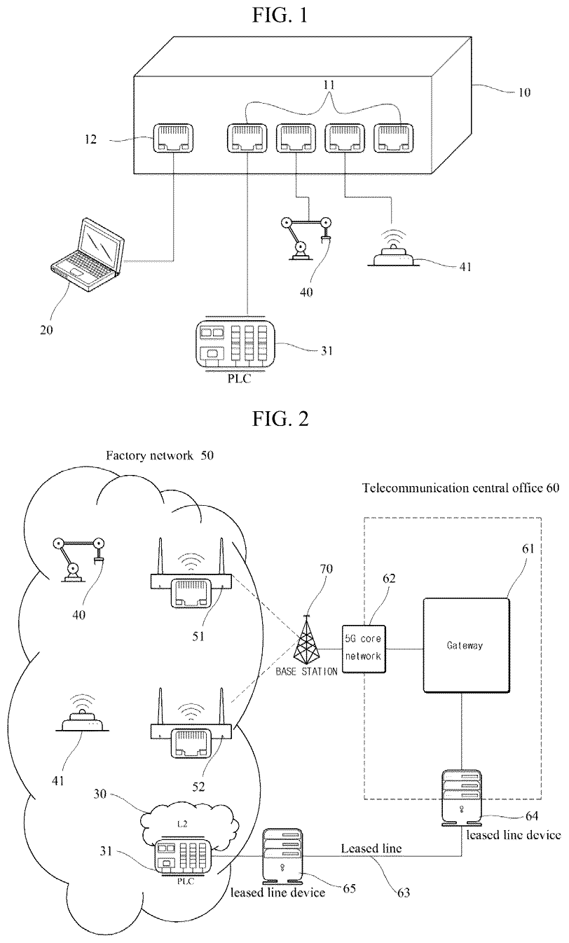

To aid in the explanation of the present embodiments, a typical L2 switch used in a typical industrial local area network will be described with reference to FIG. 1. Additionally, the dedicated line interworking method for the interconnection between the 5G core network and the customer's internal wired network will be described with reference to FIG. 2.

FIG. 1 illustrates a typical L2 switch that establishes an Ethernet network for a local area network (LAN).

Referring to FIG. 1, typical L2 switch 10 may form an Ethernet network for local area networks (LANs). For example, various types of devices 20, 40, and 41 are connected to typical L2 switch 10 through an Ethernet cable, referred to as a wired link. Typical L2 switch 10 forms an Ethernet network for connected devices 20, 40, and 41.

Typical L2 switch 10 works at the data link layer (e.g., layer 2) and handle local network traffic, referred to as L2 traffic. Typical L2 switch 10 uses Media Access Control (MAC) addresses, which are unique identifiers for devices on the local area network, to send data to a destination device. However, typical L2 10 switch can't send data to other networks, such as the Internet. Typical L2 switch 10 is limited to handle L2 traffic within the local area network (e.g., Ethernet network). Typical L2 switch 10 is used for basic local network connections, for example, linking computers, printers, and servers within the same office or home network.

Typical L2 switch 10 may be used for an Ethernet-based factory network and manage local traffic within the Ethernet-based factory network. In this case, L2 switch 10 may include consol port 12 and multiple Ethernet ports 11, as shown in FIG. 1. Consol port 12 may be connected to consol terminal 20, such as a computer, and used to configure L2 switch 10 including Ethernet ports 11.

Each Ethernet port 11 may be connected to predetermined devices, such as robot 40 or sensor 41 in the Ethernet-based factory network. Furthermore, one of Ethernet ports 11 may be connected to programmable logic controller (PLC) 31, referred to as a control terminal, for controlling devices connected to other Ethernet ports 11, such as robot 40 and sensor 41.

However, such typical L2 switch 10 has the following limitations. First, there is a limit to the number of devices it can connect. Second, there is a limitation on the distance between the devices it can connect. Third, since only wired connections are possible, there is a restriction on the mobility of devices.

For example, typical L2 switch 10 usually has 8, 16, 24, or 48 ports. Although it is possible to connect to another L2 switch to increase the number of devices that can be connected, this makes the network configuration more complex. Furthermore, typical L2 switch 10 has distance limitations. To ensure transmission speed, there is generally a maximum distance limit of about 100 meters. Additionally, unless a virtual private network (VPN) is installed, L2 switch 10 uses a single MAC address table for switching, meaning that the MAC table must be learned for each port of the L2 switch 10, making long-distance transmission impossible. Moreover, since L2 switch 10 is installed based on wired connections, it also has mobility limitations.

To overcome these limitations, 5G technology was used to partially implement wireless connections in the Ethernet based factory network. Such a 5G factory network will be explained with reference to FIG. 2.

FIG. 2 illustrates a typical 5G factory network partially implemented wireless connection.

Referring to FIG. 2, 5G factory network 50 may include industrial terminals 40 and 41 and programmable logic controller (PLS) 31. Industrial terminals 40 and 41 are respectfully connected to wireless routers 51 and 52 (e.g., 5G router) and connected to base station 70. For example, industrial terminals 40 and 41 may include robots, actuators, and sensors. That is, industrial terminals 40 and 41 are wireless connected to 5G factory network 50 through base station 70 connected to 5G core network.

Programmable logic controller (PLC) 31, also referred to as control terminal, controls industrial terminals 40 and 41. However, PLC 31 is connected to 5G factory network 50 through an Ethernet network (e.g., wired network) because of stability.

For example, all industrial terminals 40 and 41 are connected to PLC 31 and report their status in real time to PLC 31. All industrial terminals 40 and 41 may receive control signals from PLC 31.

The data traffic generated by industrial terminals 40 and 41 within 5G factor network 50 is transmitted to base station 70 via 5G routers 51 and 52. The data traffic sent to the base station 70 is then forwarded to the 5G core network 62 and gateway 61. The data traffic re-enters 5G factor network 50 through dedicated leased line 63, and it is routed back to PLC 31 connected in Ethernet network 30, which is a wired local area network.

To establish a communication path between PLC 31 in Ethernet network 30 and industrial terminals 40 and 41 in 5G core network, dedicated leased line 63 is used. Such dedicated leased line 63 is established by dedicated line device 64 and 65 installed at both 5G factor network 50 and telecommunications central office 60. However, such need of dedicated leased line 63 leads to an increase in overall service costs and makes it difficult to provide a relatively small-scale 5G L2 service for dozens of devices.

To overcome such defects of typical L2 switch and 5G factory network, this disclosure introduces a system and method that provides a virtual L2 switch service to stably connect industrial terminals wirelessly connected to the 5G network with control terminals (e.g., PLC) connected to the company's Ethernet network, without using a dedicated line.

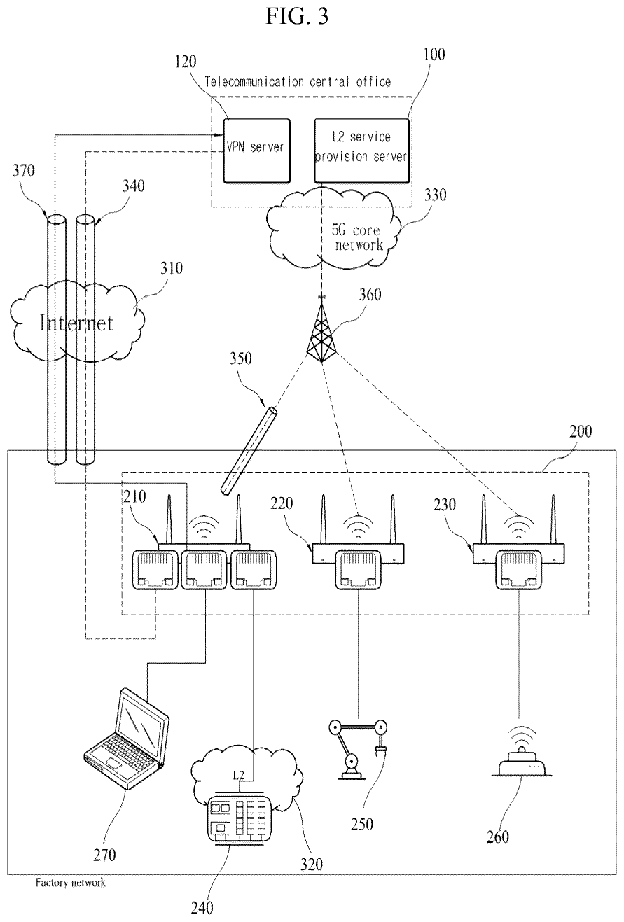

Hereinafter, the virtual L2 switch service provision system will be described in detail with reference to FIG. 3. FIG. 3 is a diagram describing a virtual L2 switch service in accordance with an embodiment.

Referring to FIG. 3, a virtual L2 switch service may be provided to predetermined customers (e.g., smart factory network) in accordance with an embodiment. The virtual L2 switch service may be a service provided to subscribers from a service provider (e.g., telecommunications service provider) by establishing at least one of virtual wired L2 network (e.g., wired network, virtual Ethernet network) and virtual wireless L2 network between industrial terminals in a factory, wirelessly connected to the 5G network, with control terminals (e.g., PLC) connected to the factory's Ethernet network.

In accordance with an embodiment, i) such a virtual L2 network may be formed between service system 100 and virtual L2 switch 200, and ii) industrial terminals 250 and 260 and PLC 240 are allowed to communicate with each other through the virtual L2 network. For example, wired L2 tunnel 340 and wireless L2 tunnel 350 may be formed between service system 100 and virtual L2 switch 200.

Referring to FIG. 3, service system 100 may include L2 service provision server 110 and virtual L2 switch 200. L2 service provision server 110 may be in a telecommunications central office, and virtual L2 switch 200 may be installed in a customer's factor network (e.g., local area network, Ethernet network). L2 service provision server 110 and virtual L2 switch 200 may be redundantly connected through wired L2 tunnel 370 and wireless L2 tunnel to ensure network connection stability. For example, PLC 240 manages all industrial terminals 250 and 260 (e.g., IoTs) in the factor network. If there is a failure in the network connected to PLC 240, the entire factory network will experience a failure. Therefore, such redundant connections through wired L2 tunnel 270 and wireless L2 tunnel improves the stability of the entire network.

Virtual L2 switch 200 may include wireless routers 220 and 240 (5G routers) each connected to corresponding industrial terminals 250 and 260 in order to allow mobility for industrial terminals 250 and 260.

The smart factory network refers to the network used in a smart factory, where information, such as machine status or progress rates, is collected in real time through information and communication technology (ICT). In a smart factory, Internet of Things (IoT) devices 250 and 260 are installed on equipment and machinery to collect real-time progress data, which is then analyzed. Based on the analyzed data, IoT devices 250 and 260 wireless connected within the smart factory may be controlled by control terminal 240 connected through a wired network within the smart factory.

In accordance with an embodiment, virtual L2 switch 200 may be installed in the smart factor network and include 5G master router 210 (hereinafter referred to as ‘master router’ for the sake of convenience in the explanation) and multiple 5G wireless routers 220 and 230 (hereinafter referred to as ‘wireless routers’ for the sake of convenience in the explanation).

In the embodiment, two wireless routers 220 and 230 are used as examples for the sake of convenience in explanation, but it is not limited to this. Furthermore, in the embodiment, master router 210 and wireless routers 220 and 230 are described as a 5G-based virtual L2 switch 200 for convenience, but this is not necessarily limited to this configuration.

In accordance with an embodiment, master router 210 may be a 5G router capable of forming wireless L2 tunnel (e.g., 5G L2 tunnel) 350 to base station 70 and deliver data traffic generated by devices connected thereto to virtual L2 switch serviced provision system 100 through a 5G core network.

In addition, master router 210 may be equipped with multiple Ethernet ports. For example, master router 201 may include three ports, as shown in FIG. 3. The first port of master router 210 may be an Internet port connected to the Internet 310. That is, the first port of master router 210 may form a wired L2 tunnel between any devices connected to master router 210 (e.g., consol terminal 270 and PLC 240) and service system 100 located at the telecommunications central office through the Internet 310.

The second port of master router 210 may be connected to console terminal 270 through a wired link (e.g., Ethernet cable). In response to instructions from a customer, consol terminal 270 may activate the virtual L2 switch service or input information for configuring virtual L2 switch 200. (e.g., configuration information) That is, the first port of master router 210 may form a duplicated L2 tunnel in addition to wireless L2 tunnel 350 for stably delivering L2 traffic to ensure reliable service support.

The third port of the master router 210 may be connected to programable logic controller (PLC) 240 for controlling industrial terminals 250 and 260 connected to the factory network and connect PLC 240 to L2 service provision server 100.

Through master router 210, L2 traffic generated in the smart factory network is transmitted to the telecommunications central office via redundant tunnels, namely i) wired L2 tunnel 340 connected through the Internet 310 (hereinafter referred to as ‘Internet L2 tunnel’ for the sake of convenience in the explanation) and ii) wireless L2 tunnel 350 connected through 5G (thereinafter referred to as ‘5G L2 tunnel’ for the sake of convenience in the explanation), using the 5G core network 330.

Additionally, master router 210 may form L3 control tunnel 370 connected to L2 service provision server 100 through the Internet 310. Through such L3 control tunnel 370, master router 210 may receive control data from L2 service provision server 100 in the telecommunications central office. In other words, master router 210 establishes three tunnels: Internet L2 tunnel 340, 5G L2 tunnel 350, and Internet L3 tunnel 370.

Industrial terminals 250 and 260 are respectfully connected to wireless routers 220, and 230 via wired connections. The L2 traffic generated by the industrial terminals 250 and 260 is transmitted wirelessly through the wireless routers 220 and 230, passes through the 5G core network 330, and is sent to service system 100. Industrial terminals 250 and 260 refer to equipment, machines, and devices installed in the smart factory.

As shown in FIG. 3, L2 service provision server 110 and virtual L2 switch 200 are interconnected through 5G core network 330 and the internet 310 without using the dedicated line or the dedicated line devices, where were used in typical system. That is, L2 service provision server 110 and virtual L2 switch 200 may form a virtual L2 network and allows all of i) devices connected to an Ethernet network and ii) devices wirelessly connected to the 5G core network to communicate with each other as if all devices are connected to a single L2 network.

As described, master router 210 may establish redundant virtual wired and wireless L2 tunnels to L2 service provision server 110 in accordance with an embodiment. Because of such redundant virtual wired and wireless L2 tunnels, without a dedicated leased line, industrial terminals connected to a 5G core network are able to communicate with a control terminal (PLC) connected to an Ethernet network. Hereinafter, master router 210 will be described in more detail.

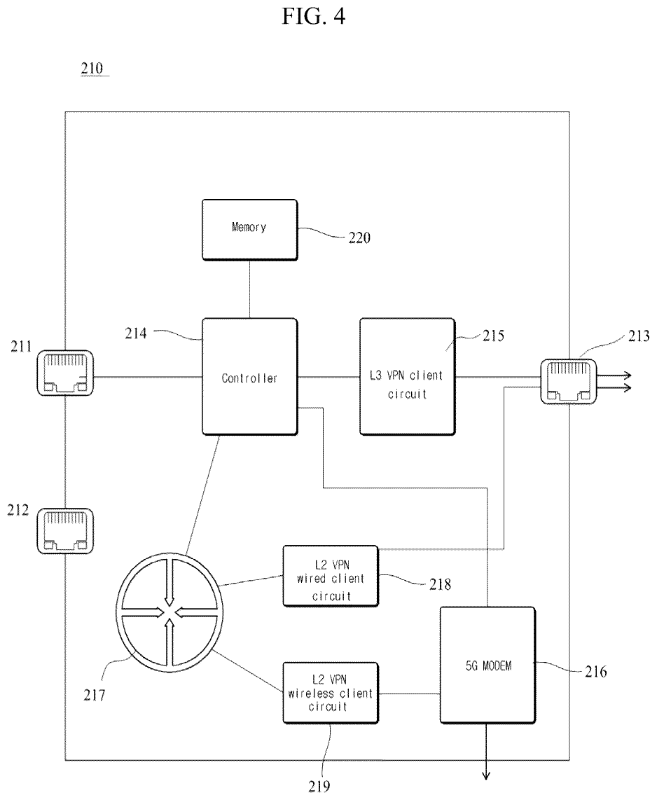

FIG. 4 is a block diagram illustrating a master router in accordance with an embodiment.

Referring to FIG. 4, master router 210 may include consol port 211, Ethernet port 212, Internet port 213, router controller 214, layer 3 virtual private network (L3 VPN) client 215, 5G MODEM 216, switch 217, layer 2 (L2) VPN wired client 218, and L2 VPN wireless client 219 in accordance with an embodiment.

In accordance with an embodiment, consol port 211 may be a local area network (LAN) port (e.g., Ethernet port) to be connected to console terminal 270 through a wired link (e.g., Ethernet cable). Consol port 211 may provide a pathway that connects console terminal 270 to router controller 214 inside master router 210. For activating the virtual L2 switch service, a user (e.g., customer, subscriber) may access a predetermined website of a service provider using consol terminal 270 connected to master router 210 through consol port 211. Additionally, a user may modify the configuration information of virtual L2 switch 200 using console terminal 270. Consol terminal 270 may be a standard personal computer (PC), laptop, or other similar devices, and is not limited to any one type.

In accordance with an embodiment, ethernet port 212 may be connected to PLC 240 through another local area network within the factory network (e.g., L2 network). Alternatively, Ethernet port 212 may be used for connecting master router 210 to another L2/L3 network, such as L2/L3 wired backbone network 320.

In accordance with an embodiment, Internet port 213 may be connected to the Internet 310. That is, Internet port 213 may connect master router 210 to the Internet 310. Internet port 213 may be used to establish a communication path from consol port 211 or Ethernet port 212 to virtual L2 service provision server 110 via Internet 310 by forming wired L2 tunnel 340.

In accordance with an embodiment, router controller 214 may be a processor that perform operations to control constituent elements of master router 210 automatically, in response to user inputs received through consol terminal 270, or in response to data received through ports 211, 212, and 213. Further, router controller 214 may control the constituent elements of master router 210 to perform operations for providing the virtual L2 switch service that establishes the virtual L2 network between virtual L2 switch 200 and service system 100. Memory 219 is an electric device that stores data and instructions temporarily or permanently. Based on the stored data and instructions, router controller 214 may perform necessary operations for providing the virtual L2 switch service.

In accordance with an embodiment, L3 VPN client circuit 215 may be a circuit that establishes Layer 3 virtual private network tunnel (L3 VPN tunnel) 370 between master router 210 and VPN server 120. L3 VPN tunnel 370 may be referred to as a control tunnel. Through such L3 VPN tunnel 370, router controller 214 may be connected to VPN server 120. Since VPN server 120 is connected to virtual L2 service provision server 110, router controller 214 ultimately establishes a connection path to L2 service provide server 111.

In accordance with an embodiment, L2 VPN wired client circuit 218 may be a circuit that establishes a Layer 2 virtual Private network (L2 VPN) using a wired connection (e.g., Ethernet). L2 VPN wired client circuit 218 may form wired L2 tunnel 340 by cooperation with VPN server 120 in service system 100. Wired L2 tunnel 340 may be a virtual wired L2 communication path that delivers L2 data generated by devices connected to Ethernet port 212 to industrial terminals connected to wireless routers 220 and 230 or that delivers another L2 data generated by industrial terminals connected to wireless routers 220 and 230 to devices connected to Ethernet port 212. That is, L2 data from devices connected consol port 211 and Ethernet port 212 may be transmitted to service system 100 through wired L2 tunnel 340 formed through the Internet 310. Further, another L2 data collected from industrial terminals 250 and 260 are delivered to devices connected to consol port 211 and Ethernet port 212 through wired L2 tunnel 340.

Wired L2 tunnel 340 finally forms a path to L2 data gateway 140 through L2 VPN server of VPN server 120. At this time, L2TP (Layer 2 Tunneling Protocol) or VXLAN (Virtual Extensible LAN) may be used between master router 210 and VPN server 120. VXLAN, among other protocols, may also be used between VPN server 120 and L2 data gateway 140. Since the functions of L2TP and VXLAN are already well known, a detailed explanation is omitted in this embodiment of the present invention.

In accordance with an embodiment, 5G modem 216 may be a device that enables connectivity to 5G networks. That is, 5G modem 216 enables communication between a device connected to Ethernet port 212 and 5G core network 330. For example, 5G modem 216 converts digital data into signals that can be transmitted over the 5G network and vice versa.

5G modem may connect master router 210 to 5G core network 330 via base station 360 and enable master router 210 to transmit and receive L2 traffic using wireless L2 tunnel 350. 5G core network 330 may include mobility management entity (MME), access and mobility management function (AMMF), and session management function (SMF) for mobility and session managements.

In accordance with an embodiment, L2 VPN wireless client circuit 219 may be a circuit that establishes a Layer 2 virtual Private network (L2 VPN) using a wireless connection made through 5G modem 216. L2 VPN wireless client circuit 219 may form wireless L2 tunnel 350 by cooperation with VPN server 120 in service system 100 through a communication path made by 5G modem 216, base station 360, L2 data gateway 140.

Wireless L2 tunnel 350 may be a virtual wireless L2 communication path that delivers L2 data generated by devices connected to Ethernet port 212 to industrial terminals connected to wireless routers 220 and 230 or that delivers another L2 data generated by industrial terminals connected to wireless routers 220 and 230 to devices connected to Ethernet port 212

In accordance with an embodiment, master router 210 includes switch 217 and employ a spanning tree protocol (STP) or similar as a protocol used for selecting one of two tunnels 340 and 350. Through the communication protocol, switch 217 switches one communication tunnel to the other according to a control signal from router controller 210 which is determined based on predetermined conditions. For example, a communication tunnel for transmitting L2 traffic may be selected between wired L2 tunnel 340 and wireless L2 tunnel 350. According to the selected communication tunnel, switch 217 may control a L2 traffic path to one of L2 VPN wired client 218 and L2 VPN wireless client 219.

STP is a network protocol used for preventing loops in Ethernet networks. When multiple paths exist between switches, loops can form, causing network instability. STP works by identifying and disabling redundant paths, ensuring a loop-free topology while keeping backup paths available in case the primary path fails.

The embodiments are described as using the SPT communication protocol for selecting one of two tunnels 340 and 350 and switching switch 217. However, the embodiments are not limited thereto. Any protocol can control switch 217 for selecting one of communication tunnels based on predetermined conditions may be utilized.

As described above, the virtual L2 switch service provides dual connections that allow L2 traffic to be transmitted and received between the virtual L2 switch 200 and service system 100 via either i) wired L2 tunnel 320 or ii) wireless L2 tunnel 350 (5G L2 tunnel), which is connected to 5G core network 330 through 5G MODEM 216. As described, wired L2 tunnel 320 may be referred to as an Ethernet L2 tunnel and formed through Internet 310. Wireless L2 tunnel 320 may be referred to as 5G L2 tunnel and formed through 5G MODEM 216 connected to 5G core network 330.

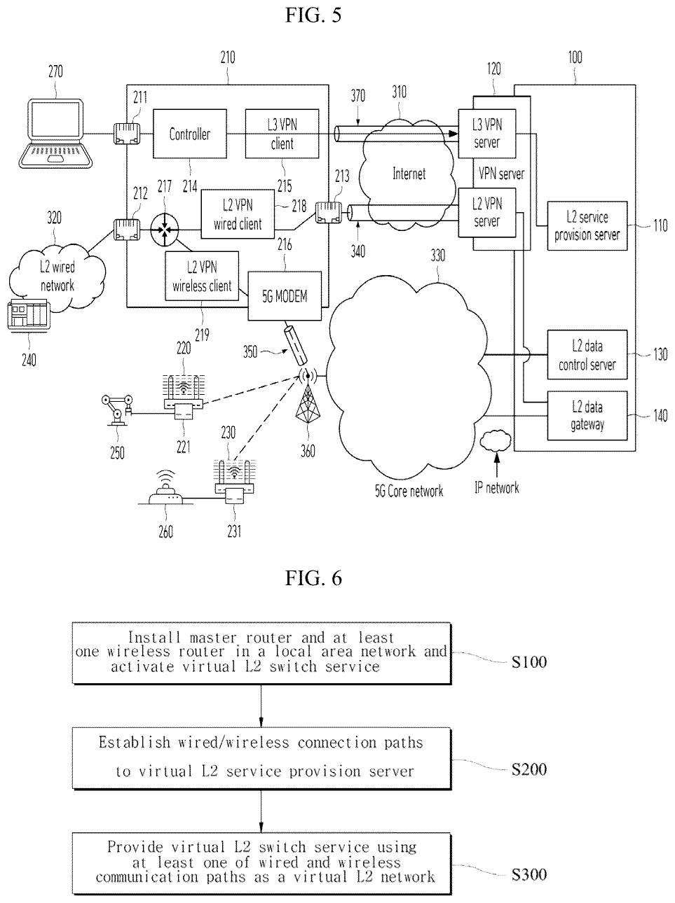

Hereinafter, a method of providing a virtual L2 switch service in accordance with an embodiment will be described with reference to FIG. 5.

FIG. 5 is a diagram illustrating providing a virtual L2 switch service in accordance with an embodiment. That is, FIG. 5 illustrates forming a wired L2 tunnel and a wireless L2 tunnel, as a virtual L2 network, between a virtual L2 switch installed at a local area network and a virtual L2 switch service provision system deployed at a telecommunication central office in accordance with an embodiment.

Referring to FIG. 5, for providing a virtual L2 switch service, master router 210 may be installed in a subscriber's local area network (e.g., smart factory network), together with wireless routers 220 and 230. In addition, L2 service server 100 may be deployed at a predetermined remote location such as a telecommunication central office. When the virtual L2 switch service is activated, master router 210 may form at least one of i) wired L2 tunnel 340, ii) wireless L2 tunnel 350, and iii) L3 tunnel 370 to L2 service provision server 100 as the virtual L2 network.

As shown in FIG. 5, master router 210 may be connected to console terminal 270 through consol port 211. Master router 210 may form L3 VPN tunnel 370 between master router 210 and VPN server 120 through L3 VPN client circuit 215. Through such L3 VPN tunnel 370, master router 210 ultimately establishes a connection path to L2 service provision server 110. Through VPN server 120.

Master router 210 may be connected to PLC 240 in the factory network (e.g., L2 network) through Ethernet port 212. Alternatively, master router 210 may be connected to another L2/L3 network, such as L2/L3 wired backbone network 320 through Ethernet port 212.

Master router 210 may be connected to the Internet 310 through Internet port 213. That is, master router 210 may establish wired L2 tunnel 340 to L2 service provision server 110 via Internet 310.

As described, the virtual L2 switch service provides dual connections that allow L2 traffic to be transmitted and received between the virtual L2 switch 200 and service system 100 via either i) wired L2 tunnel 320 or ii) wireless L2 tunnel 350 (5G L2 tunnel), which is connected to 5G core network 330 through 5G MODEM 216. As described, wired L2 tunnel 320 may be referred to as an Ethernet L2 tunnel and formed through Internet 310. Wireless L2 tunnel 320 may be referred to as 5G L2 tunnel and formed through 5G MODEM 216 connected to 5G core network 330.

Master router 210 may transmit L2 traffic to and receive L2 traffic from L2 service provision server 110 via wired L2 tunnel 340 and wireless L2 tunnel 350. Master router 210 includes switch 217 and employ a spanning tree protocol (STP) or similar as a protocol used for selecting one of two tunnels 340 and 350. For example, a communication tunnel for transmitting L2 traffic may be selected between wired L2 tunnel 340 and wireless L2 tunnel 350. According to the selected communication tunnel, switch 217 may control a L2 traffic path to one of L2 VPN wired client 218 and L2 VPN wireless client 219.

In accordance with an embodiment, wired L2 tunnel 340 is established to L2 data gateway 140 through L2 VPN server 120. That is, L2 traffic generated by devices connected consol port 211 and Ethernet port 212 may be transmitted to service system 100 through wired L2 tunnel 340 formed through the Internet 310. Further, another L2 traffic collected from or generated by industrial terminals 250 and 260 are delivered to devices connected to consol port 211 and Ethernet port 212 through wired L2 tunnel 340.

L2TP (Layer 2 Tunneling Protocol) or VXLAN (Virtual Extensible LAN) may be used for wired L2 tunnel 340 between master router 210 and VPN server 120. VXLAN may also be used for an additional L2 tunnel formed between VPN server 120 and L2 data gateway 140.

In accordance with an embodiment, virtual L2 switch 200 may include multiple wireless routers 220 and 230. Wireless routers 220 and 230 are each connected to assigned industrial terminals, such as robots, sensor, and actuators 250 and 260. In particular, wireless routers 220 or 230 may include at least one Internet port connected to corresponding industrial terminals.

Wireless routers 220 and 230 are each equipped with one or more wired Ethernet ports 221, 231. Industrial terminals such as robots, sensors, and actuators 250 and 260 are connected through these wired Ethernet ports 221 and 231. Alternatively, an additional L2 switch can be used to expand the number of ports.

As described above, virtual L2 switch 200 may configure the virtual L2 network and transmit L2 traffic through base station 360 and 5G core network 330 via wireless L2 tunnel to L2 data gateway 140. L2 data gateway 140 receives L2 traffic, connects mater router 210 and multiple wireless routers 223 and 230 into a single L2 network. In other words, master router 210 and multiple wireless routers 220 and 230 operate as if they are connected to a single L2 switch, and they switch traffic using a shared MAC address table like a single L2 switch in accordance with an embodiment.

In accordance with an embodiment, service system 100 may include VPN server 120, Virtual L2 service provision server 110, L2 data control server 130, and L2 data gateway 140.

VPN server 120 may be deployed between Internet 210 and virtual L2 service provision server 110 at the telecommunications central office. When connected to master router 210, it acta as a gateway to Internet 310. Additionally, VPN server 120 is responsible for protecting and connecting various service servers (not shown) located within the internal network of the telecommunications central office.

VPN server 120 includes two types of VPN servers, an L3 VPN server connected to Virtual L2 service provision server 110, and an L2 VPN server responsible for wired connections to support wired/wireless backup structures from mater router 210. For convenience of explanation, these are collectively referred to as VPN server or the L3 VPN server.

Virtual L2 service provision server 110 acts as a server in HTTP or socket communication. Console terminal 270 or control module 214 within master router 210 servers as the client. Virtual L2 service provision server 110 stores customer-specific control information for customers subscribed to the L2 service or may transmit it to the L2 data control server 130.

L2 data control server 130 may control the L2 service based on customer-specific control information received from virtual L2 service provision server 110. Specifically, L2 data control server 130 provides L2 traffic control functions, such as learning, filtering, forwarding, flooding, VLAN support, and trunk configuration, which are key functions of a typical L2 switch. Since the functions of the L2 switch are already well known, a detailed explanation is omitted herein.

L2 data gateway 140 is the endpoint that handles tunneling for master router 210 and wireless routers 220, 230. Additionally, L2 data gateway 140 processes virtual L2 services such that L2 traffic from wireless routers 220 and 230, master router 210, and the wired connections are all handled as if they are on a single L2 switch.

Hereinafter, a preparation procedure for providing a virtual L2 switch service will be described with reference to FIG. 6. FIG. 6 is a flowchart illustrating a preparation procedure for providing a virtual L2 switch service in accordance with an embodiment.

Referring to FIG. 6, to use the virtual L2 switch service, a customer, such as an individual or a company, may access a website of a service provider and request the virtual L2 switch service through the website. For example, a customer may select a required router model, quality, and payment plan through a given virtual L2 switch service subscription process. Then, the service provider may ship necessary equipment, such as master router 210 and wireless routers 220 and 230 to the customer's location to be installed in the factory network.

After the customer installs master router 210, wireless routers 220 and 230, and consol terminal 270, the virtual L2 switch service is activated through control terminal 270 at step S100. At this time, if necessary, subscription information for the virtual L2 switch service may be sent to L2 service provision server 100.

Once all settings for using the virtual L2 switch service are completed, virtual L2 switch 200 including master router 210 and wireless routers 220 and 230 may attempt to connect to the L2 service server 100 via both wired and wireless connections simultaneously at step S200.

After virtual L2 switch 200 including master router 210 and wireless routers 220 and 230 is connected to L2 service provision server 100, a virtual L2 network may be established at step S300. That is, the virtual L2 switch service is provided to the subscriber as if all devices (e.g., PLC, consol terminal, industrial terminals) are connected to a single L2 switch. In other words, in accordance with an embodiment, all devices connected to the virtual L2 network via a wired L2 tunnel and via the wireless L2 tunnel can communicate with each other as if both are connected to the same L2 network.

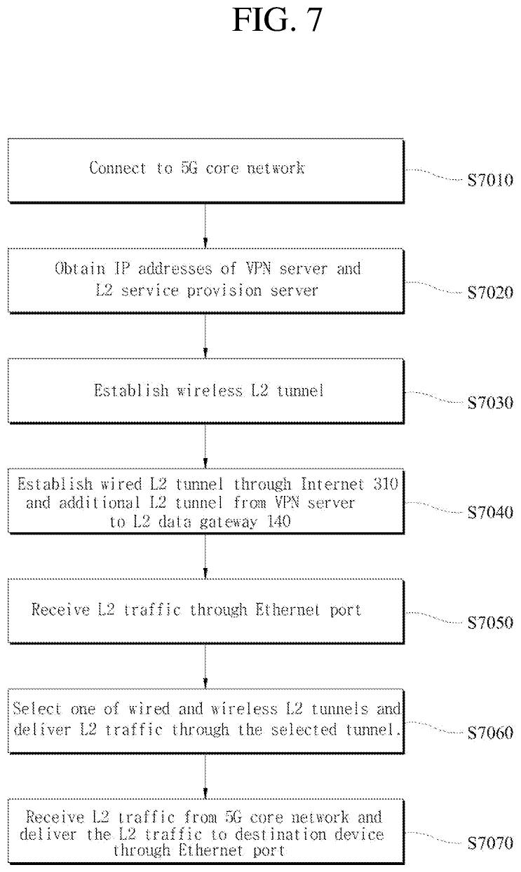

Hereinafter, a method of a master router for establishing a virtual L2 network will be described in more detail with reference to FIG. 7. FIG. 7 is a flowchart illustrating a method of a master router for providing virtual L2 switch service in accordance with an embodiment.

Referring to FIG. 7, master router 210 connects to 5G core network 330 through base station 360 upon the initiation of master router 210 and obtains an IP address from 5G core network 330 after authentication at step S7010.

Master router 210 inquires a wireless DNS with a predefined host name, obtains IP addresses of service servers (e.g., L2 service provision server 110, L2 data control server 130, and L2 data gateway 140) through wireless L2 client circuit 219 and 5G modem 216 and requests connection to L2 data gateway 140 at step S7020.

According to the request, master router 210 establishes wireless L2 tunnel 350 to L2 data gateway 140 at step S7030.

After establishing wireless L2 tunnel 350, master router 210 inquires an Internet DNS with the predefined host name, obtains an IP address of L2 VPN server 120, establishes wired L2 tunnel 340 at step S7040

Master router 210 finally establishes the virtual L2 network (e.g., End-to-End Layer 2 tunnel: E2E L2 tunnel) from master router 210 to L2 data gateway 140 through VPN server 120 by establishing additional wired L2 tunnel between L2 VPN server 120 and L2 data gateway 140 at step S7050.

After forming the virtual L2 network, master router 210 receives L2 traffic and determines the destination of the received L2 traffic at step S7060.

Master router 210 delivers the received L2 traffic through at least one of wired tunnel 340 and wireless tunnel 350 using a predetermined protocol, such as spanning tree protocol, at step S7070.

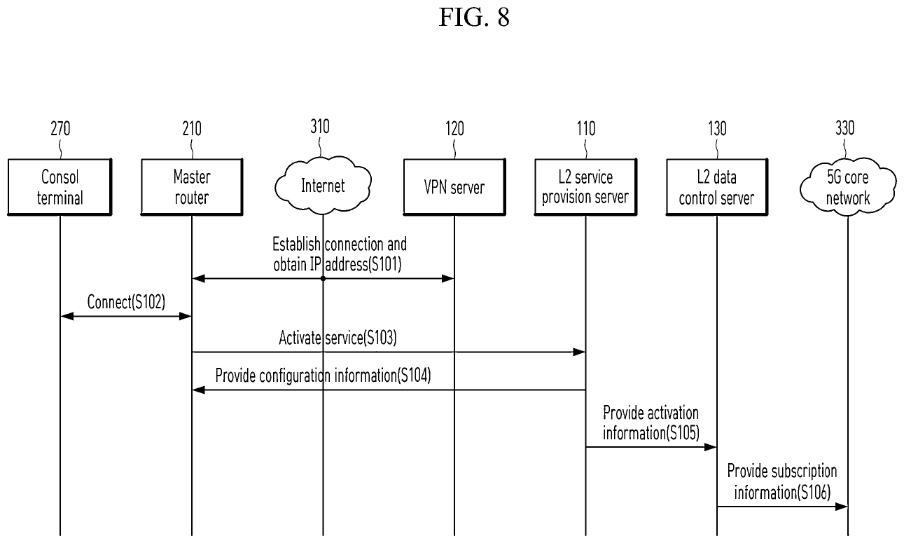

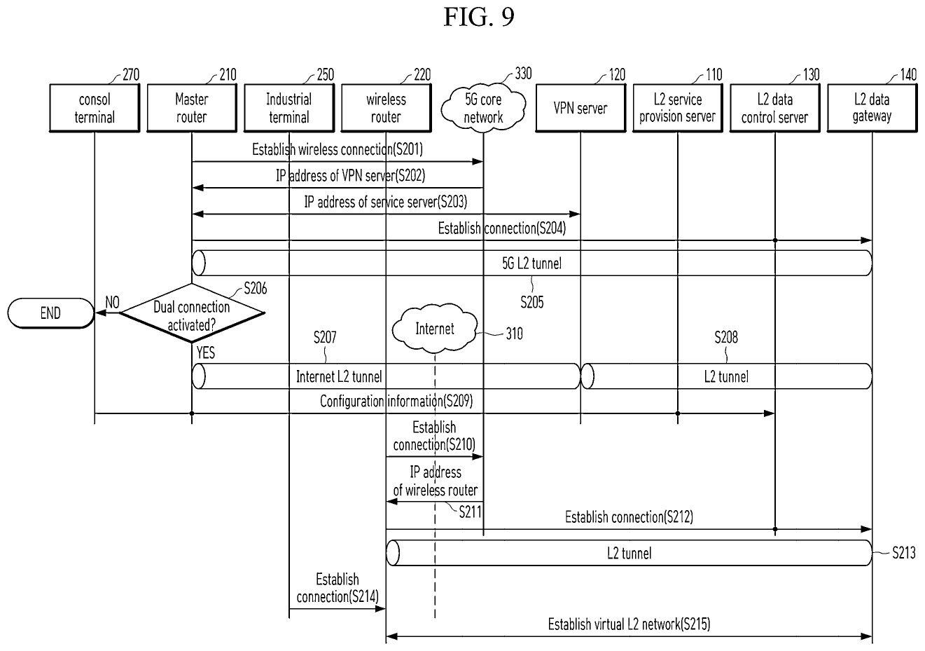

Hereinafter, a method for providing a virtual L2 switch service in accordance with another embodiment will be described with reference to FIG. 8 and FIG. 9. FIG. 8 and FIG. 9 are signal diagrams illustrating providing a virtual L2 switch service in accordance with another embodiment.

As described, customers may request the virtual L2 switch service through a web portal, call center, or sales representative. At this time, the customer selects the number of required terminals, service plan, terminal model, etc., and based on the customer's application information, they receive either the master router 210 or both the master router 210 and the wireless router 220. In this embodiment, for the sake of explanation, one master router 210 and one wireless router 220 are illustrated and explained. To activate the virtual L2 switch service, a customer connects master router 210 to Internet 310 using Internet port 213 of master router 210 and starts (e.g., boots up) master router 210 as described above with reference to FIG. 5.

FIG. 8 is a signal diagram illustrating an activation procedure of a virtual L2 switch service in accordance with an embodiment. Referring to FIG. 8, upon the initiation of master router 210, L3 VPN client 215 of master route 210 attempts connection to VPN server 120, and mater router 210 obtains an IP address of VPN server 120 through Internet 310 at step S101.

At step S102, consol terminal 270 may be connected to master router 210 through consol port 211, and master router 210 assigns the IP address obtained from the VPN server 120 to consol terminal 270. At step S103, consol terminal 270 accesses L2 service provision server 110 in response to a user's instruction and activate the virtual L2 switch service.

At step S104, L2 service provision server 110 may provide master router 210 with service information necessary for the virtual L2 switch service, such as an IP address of a wired L2 VPN server in VPN server 120, a domain name server (DNS) host name, and so forth.

At step S105, virtual L2 service provision server 110 transfers service information to L2 data control server 130. At step S106, L2 data control server 130 may transmit corresponding subscription information for virtual L2 switch service to 5G core network 330 including unified data repository (UDR) and policy control function (PCF). Although steps S101 to S106 are described as being performed only once when the virtual L2 switch service is initially activated, this is not necessarily limited to that scenario.

As described, the virtual L2 switch service is activated through steps S101 to S106 shown in FIG. 8. Hereinafter, a procedure of establishing wireless connection between master router 210 and service system 100 will be described in more detail with reference to FIG. 9. FIG. 9 is a signal diagram illustrating establishing wireless connections between master router 210 and service system 100.

Referring to FIG. 9, master router 210 attempts wireless connection to 5G core network 330 at step S201. At step S202, master router 210 obtains an IP address of VPN server 120. At step S203, master router 210 inquires wireless domain name server (DNS) with a predetermined host name through 5G Modem 216 and obtains IP address of servers which provide L2 services, such as L2 service provision server 110, L2 data control server 130, and L2 data gateway 140. At step S204, master router 210 connects L2 data control server 130 and L2 data gateway 140 using the obtained IP addresses. At step S205, master router 201 establishes wireless L2 tunnel 350 to L2 data gateway 140.

As shown, through S201 to S205, wireless L2 tunnel 350 may be established to L2 service provision server 110 through L2 data gateway 140 in accordance with an embodiment.

At step S206, master router 210 determines whether the dual connection configuration of wired and wireless connections is set to ‘activated’ based on the customer's subscription information. If the dual connection configuration is set to ‘activated’, master router 210 attempts to create Internet L2 tunnel 340 through the network path connected to the Internet 310.

At step S207, master router 210 quires the Internet DNS using the hostname included in the service information obtained from the L2 service provision server 110 in step S104 and establishes wired L2 tunnel 340 by connecting to the VPN server 120. The service information may include information on an IP address of a wired L2 VPN server included in VPN server 120, a DNS host name, and so forth.

Here, the method of the master router 210 for querying the Internet DNS using the hostname, or the method of creating the Internet L2 tunnel using the queried Internet DNS, may be implemented in various ways. Therefore, embodiments are not limited to any one method.

At step S208, VPN server 120 and L2 data gateway 140 establish additional L2 tunnel for a corresponding customer. Then, finally, Internet L2 tunnel 340 is established from the master router 210 to VPN server 120 and from VPN server 120 to L2 data gateway 140.

The reason for tunneling the wired L2 tunnel in two stages, step S207 and S208, is to separate and protect the network used by the L2 data gateway 140 and the telecommunications central office's network where the L2 data gateway 140 is formed, from the Internet 310.

Finally, master router 210 secures both wireless L2 tunnel 350 (e.g., 5G L2 tunnel) and wired L2 tunnel 340 (e.g., Internet L2 tunnel). Then, through the internet redundance processing routine within master router 210, it can provide a wireless/wired dual L2 network mechanism.

At this time, if consol terminal 270 is connected to master router 210, consol terminal 270 may modify detailed configuration information necessary for the virtual L2 switch service, such as VLAN settings or various setting like access/trunk port configuration. Additionally, if it is necessary to connect L2/L3 wired backbone network to the master router 210, such a L2/L3 wired backbone network may be connected through Ethernet port 212 within master router 210.

At step S209, the modified information through consol terminal 270 may be transferred to L2 data control server 130. Such an additional process may or may not be executed, and since the metho of changing configuration information is already known technology, detailed explanation is omitted.

At step S210, wireless router 220 attempts to connect to 5G core network 350 through base station 360 as soon as it is initiated. For example, if the customer wishes to use additional wireless router 220 and installs additional wireless router 220 connected to predetermined industrial terminal in the factory network, newly installed wireless router 220 attempts to connect to the 5G core network 330 through the base station as soon as it boots up.

At step S211, wireless router 220 obtains an IP address to be used from 5G core network 330. At step S212, wireless router 220 (e.g., L2 client) quires a wireless DNS using a predetermined hostname and obtain a connection point address (IP address) of L2 data control server 130. Once wireless router 220 has obtained the connection point address, it attempts to establish an L2 tunnel connection to the L2 data gateway 140 through L2 data control server 130

At step S213, L2 tunnel is established from wireless router 220 to L2 data gateway 140. When industrial terminal 250 attempts to connect to wireless router 220 at step S214, the L2 connection from industrial terminal 250 to L2 data gateway 140 is completed at step S215.

As a result, the industrial terminal 250 is connected to the L2 data gateway 140 through wireless tunnel, such as 5G tunnel. The pre-established 5G L2 tunnel is directly integrated with the L2/L3 wired backbone network through the master router 210, functioning as if they are all connected to a single L2 switch.

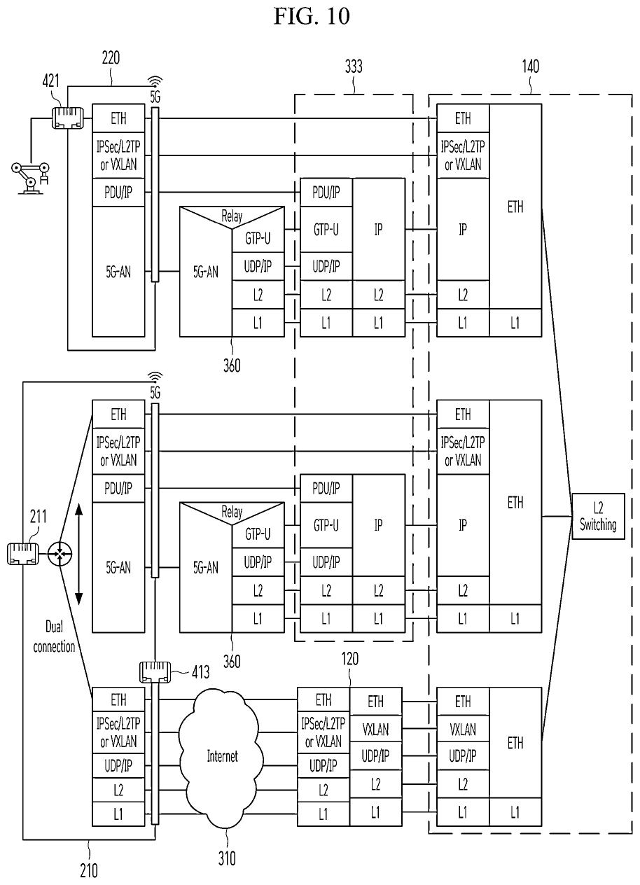

Hereinafter, the user data connection structure and protocol stack of the virtual L2 switch service will be described with reference to FIG. 10.

FIG. 10 is an exemplary diagram of a user data connection structure and protocol stack of a virtual L2 switch service according to an embodiment of the present invention.

Referring to FIG. 10, the connection configuration and protocol stack of the user data plane among the master router 210, wireless router 220, L2 data gateway 140, and wired/wireless network nodes (e.g., base station 360), 5G core network gateway 333, VPN server 120, Internet 310, after the service configuration procedure described in FIG. 6 and FIG. 7 are completed.

That is, in the embodiment, the connection section between master router 210 and L2 data gateway 140 is dualized using both wired and wireless connections to ensure network stability. Meanwhile, the wireless router 220 connects to the L2 data gateway 140 wirelessly to provide mobility.

As described above, service system 100 includes VPN server 120, L2 service provision server 110, L2 data control server 120, and L2 data gateway 140. Virtual L2 switch 200 includes master router 210 and wireless router 220. Such constituent elements of service system 100 and virtual L2 switch 200 may be implemented as a computing system. For example, the computing system executes a program that contains instructions described to perform the operations of the embodiments. The program can be stored and distributed on computer-readable storage media.

The computing system may include at least one processor, a memory, and a communication interface, which may be connected via a bus. Additionally, input and output devices may be included. The computing system may be equipped with various software, including an operating system that runs the programs.

The processor controls the operation of the computing system. The processor may be any form of processor the processes the instructions included in the program. For example, the processor be a central processing unit (CPU), a micro processor unit (MPU), micro controller unit (MCU), graphic processing unit (GPU), or other types.

The memory loads the program so that the instructions described to execute the operation of the embodiments can be processed by the processor. The memory may include, for example, read only memory (ROM), random access memory (RAM), or other types. The memory stores various data and programs required to execute the operation of the embodiments described above. The communication interface may be a wired or wireless communication circuit.

According to the embodiments, an interworking structure is utilized without dedicated lines. Therefore, the service cost may be reduced, allowing services to be provided at a lower price, and making it possible to offer small-scale services as well.

According to the embodiments, superior mobility may be provided compared to the fixed-port method of traditional (e.g., typical) wired physical L2 switches.

According to the embodiments, without the need for additional equipments such as dedicated lines, virtual L2 switches may be provided to customers anywhere through a mobile communication network, using only the configuration of an L2 master router and L2 wireless routers.

According to the embodiment, customers can easily access services that enable wireless connectivity via 5G for L2-dependent areas, such as wireless implementation in factories using Non-IP, remote L2 access, user DHCP (Dynamic Host Configuration Protocol) processing, and L2 broadcasting, all at a reasonable cost.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present disclosure can be embodied in the form of methods and apparatuses for practicing those methods. The present disclosure can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present disclosure can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present disclosure can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

No claim element herein is to be construed under the provisions of 35 U.S.C. § 112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A virtual Layer 2 (L2) switch for providing a virtual L2 switch service to a factory network that includes at least one control device connected to the factory network through an L2 network and industrial terminals connected to the factory network through a wireless mobile network, the virtual L2 switch comprising:
a plurality of wireless routers respectively connected to industrial terminals in the factory network, each configured to wirelessly connect a corresponding one of the industrial terminals to a service system in a remote location through the wireless mobile network; and
a master switch connected to the at least one control device in the L2 network within the factory network, connected to the service system through both Internet network and the wireless mobile network, and configured to establish a virtual L2 network between the at least one control device and the industrial terminals through the service provision server and enable the at least one control device and the industrial terminals to communicate with each other through the virtual L2 network.

2. The virtual L2 switch of claim 1, wherein the master switch establishes, as the virtual L2 network, a wired L2 tunnel to the service system through the Internet network and a wireless L2 tunnel to the service system through the wireless mobile network.

3. The virtual L2 switch of claim 2, wherein the master switch receives L2 data traffic from and generated by the control device and delivers the received L2 data traffic through one of the wired L2 tunnel and the wireless L2 tunnel to the industrial terminals.

4. The virtual L2 switch of claim 2, wherein the master switch receives L2 data traffic from and generated by the industrial terminals through one of the wired L2 tunnel and the wireless L2 tunnel and delivers the received L2 data traffic to the control device.

5. The virtual L2 switch of claim 2, wherein, as the wired L2 tunnel, the master switch separately establishes a first wired L2 tunnel from the master switch to a virtual private network (VPN) server included in the service system and a second wired L2 tunnel from the VPN server to a L2 data gateway of the service system.

6. The virtual L2 switch of claim 2, wherein the master switch include a switch configured to select one of the wired L2 tunnel and the wireless L2 tunnel to transmit the L2 data based on a predetermined protocol.

7. A method for providing a virtual L2 switch service to a factory network that includes at least one control device connected to the factory network through an L2 network and industrial terminals connected to the factory network through a wireless mobile network, by using a virtual L2 switch including a plurality of wireless routers respectively connected to industrial terminals in the factory network, each configured to wirelessly connect a corresponding one of the industrial terminals to a service system in a remote location through the wireless mobile network, and a master switch connected to the at least one control device in the L2 network within the factory network, connected to the service system through both Internet network and the wireless mobile network, the method of the master switch comprising:
establishing a virtual L2 network between the at least one control device and the industrial terminals through the service provision server;
receiving L2 data traffic from the at least one control device or transmitting the received L2 data traffic to the industrial terminals through the virtual L2 network; and
receiving L2 data traffic from the industrial terminals through the virtual L2 network and delivering the received L2 data traffic to the at least one control device.

8. The method of claim 7, wherein the establishing a virtual L2 network comprises:
establishing a wired L2 tunnel to the service system through the Internet network; and
establishing a wireless L2 tunnel to the service system through the wireless mobile network.

9. The method of claim 8, wherein the establishing a wired L2 tunnel comprises:
establishing a first wired L2 tunnel from the master switch to a virtual private network (VPN) server included in the service system; and
establishing a second wired L2 tunnel from the VPN server to a L2 data gateway of the service system.

10. The method of claim 8, wherein the transmitting of the L2 data traffic from and generated by the control device comprises:
transmitting the received L2 data traffic through one of the wired L2 tunnel and the wireless L2 tunnel to the industrial terminals.

11. The method of claim 10, wherein the transmitting of the L2 data traffic from and generated by the control device further comprise:
selecting one of the wired L2 tunnel and the wireless L2 tunnel to transmit the L2 data based on a predetermined protocol.

12. A master switch for providing a virtual L2 switch service, with a plurality of wireless routers, to a factory network that includes at least one control device connected to the factory network through an L2 network and industrial terminals connected to the factory network through a wireless mobile network, the plurality of wireless routers respectively connected to industrial terminals in the factory network, each configured to wirelessly connect a corresponding one of the industrial terminals to a service system in a remote location through the wireless mobile network, the master switch comprising:
an L2 port connected to the at least one control device in the L2 network within the factory network;
an Internet port connected to the service system through Internet network;
a mobile network modem configured to connect to the wireless mobile network, and
a processor configured to establish a virtual L2 network between the at least one control device and the industrial terminals through the service provision server and enable the at least one control device and the industrial terminals to communicate with each other through the virtual L2 network.

13. The master switch of claim 12, further comprising:
a L2 virtual private network (VPN) wired client circuit configured to form a wired L2 tunnel to the service system through the Internet network; and
a L2 VPN wireless client circuit configured to form a wireless L2 tunnel to the service system through the wireless mobile network.

14. The master switch of claim 13, wherein when receiving L2 data traffic from and generated by the control device, the processor delivers the received L2 data traffic through one of the wired L2 tunnel and the wireless L2 tunnel to the industrial terminals.

15. The master switch of claim 13, wherein when receiving L2 data traffic from and generated by the industrial terminals through one of the wired L2 tunnel and the wireless L2 tunnel, the processor delivers the received L2 data traffic to the control device.

16. The master switch of claim 12, wherein, the L2 VPN wired client circuit separately establishes a first wired L2 tunnel from the master switch to a virtual private network (VPN) server included in the service system and a second wired L2 tunnel from the VPN server to a L2 data gateway of the service system.

17. The master switch of claim 13, wherein further comprising:
a switch configured to select one of the wired L2 tunnel and the wireless L2 tunnel to transmit the L2 data based on a predetermined protocol.
